(19) United States
(12) Patent Application Publication
(10) Pub. No.: US 2005/0180093 A1
(43) Pub. Date: Aug. 18, 2005

(54) Non-reciprocal circuit element

(75) Inventor: Yuichi Shimizu, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/049,918

(22) Filed: Feb. 3, 2005

(30) Foreign Application Priority Data
Feb. 17, 2004 (JP) 2004-039608

(51) Int. Cl. H01G 4/06

(52) U.S. Cl. 361/328

(57) ABSTRACT

A non-reciprocal circuit element includes a bendable dielectric which is made of a laminated plate in which insulating thin plates are laminated, first to third central conductors which are formed at different laminated locations of the dielectric to be integrated with the dielectric and which are disposed such that parts the first to third central conductors cross each other in a vertical direction, and capacitors disposed between the dielectric and a yoke. The capacitors are disposed between side plates of the yoke and bent portions bent from a base portion of the dielectric. Thus, flat portions (thickness direction) of the capacitors are provided upright with respect to a lower plate.

### BACKGROUND OF THE INVENTION

1. Field of the Invention

The present invention relates to a non-reciprocal circuit element, such as an isolator or a circulator, which can be applied to an antenna commonly-using device or the like.

2. Description of the Related Art

FIG. 6 is an exploded perspective view of a conventional non-reciprocal circuit element. Hereinafter, a configuration of the conventional non-reciprocal circuit element will be described with reference to FIG. 6. A first yoke 51 made of a boxlike magnetic plate (iron plate or the like) is boxlike and a magnet 52 having a disk shape is attached to the inside of the first yoke 51 by means of an adhesive or the like.

A second yoke 53 made of a magnetic plate (iron plate or the like) has a lower plate 53a and two side plates 53b which are bent upward from two sides facing the lower plate 53a. The second yoke 53 is coupled with the first yoke 51 to form a magnetic closed circuit.

A boxlike resin case 54 made of a synthetic resin molding product has a circular through hole 54b provided at a central portion of a lower wall 54a and a plurality of through holes 54c provided around the through hole 54b. In addition, the resin case 54 is assembled with the second yoke 53, so that the lower plate 53a is exposed to the outside through the through holes 54b and 54c.

First to third capacitors C1, C2, and C3 are formed with a chip type capacitor respectively. While being located into the through holes 54c of the resin case 54, the first to third capacitors C1, C2, and C3 are soldered to and mounted on the lower plate 53a via their lower electrodes (not shown) respectively. Further, a chip type resistor R is located into one of the through holes 54c and is soldered to and mounted on the lower plate 53a via one electrode (not shown) thereof.

In addition, the first to third capacitors C1, C2, and C3 and the resistor R are arranged parallel to the lower plate 53a in their thicknesswise directions.

On a disk-shaped ferrite member 55 made of YIG (Yttrium iron garnet) or the like, first to third central conductors 56, 57, and 58 made of metal plates are mounted. While extending from a disk-shaped ground member 59 which is located on the lower surface of the ferrite member 55, the first to third central conductors 56, 57, and 58 are bent toward the upper surface of the ferrite member 55 and parts of the first to third central conductors are arranged to cross each other in a vertical direction via a dielectric (not shown).

In addition, the first to third central conductors 56, 57, and 58 has ground portions 56a, 57a, and 58a connected to the ground member 59 and port portions 56b, 57b, and 58b provided at ends thereof.

In addition, the ferrite member 55 is located into the through hole 54b of the resin case 54 to be mounted on the resin case 54, and the ground member 59 is soldered to the lower plate 53a. Further, the port portions 56b, 57b, and 58b of the first to third central conductors 56, 57, and 58 are soldered to the other electrodes (not shown) of the first to third capacitors C1, C2, and C3 respectively. Further the port portion 58b of the third central conductor 58 is soldered to the other electrode (not shown) of the resistor R.

In addition, when the first and second yokes 51 and 53 are coupled with each other and the magnet 52 is disposed on the first to third central conductors 56, 57, and 58, the conventional non-reciprocal circuit element is formed (for example, see Japanese Unexamined Patent Application Publication No. 10-79607).

However, in the conventional non-reciprocal circuit element, since the first to third capacitors C1, C2, and C3 and the resistor R are arranged such that their flat portions (thickness direction) are parallel to the lower plate 53a, the size of the conventional non-reciprocal circuit element becomes large in a horizontal direction.

In addition, since the first to third central conductors 56, 57, and 58 are bent to cover the ferrite member 55, the manufacturing work is troublesome. In addition, when the first to third central conductors 56, 57, and 58 are bent, the positional difference may occur among the first to third central conductors 56, 57, and 58, which results in deteriorating the performance.

In addition, since the ferrite member 55 on which the first to third central conductors 56, 57, and 58 are mounted and the first to third capacitors C1, C2, and C3 are accommodated in the resin case 54, the assembling work is troublesome. As a result, the conventional non-reciprocal circuit element has poor productivity and requires high cost.

In addition, after the first to third capacitors C1, C2, and C3 are accommodated in the resin case 54, the port portions 56b, 57b, and 58b of the first to third central conductors 56, 57, and 58 should be soldered to the capacitors C1, C2, and C3 in the small space, and thus the manufacturing work is troublesome. As a result, the conventional non-reciprocal circuit element has poor productivity and requires high cost.

According to the conventional non-reciprocal circuit element, since the first to third capacitors C1, C2, and C3 and the resistor R are arranged such that their flat portions (thickness direction) are parallel to the lower plate 53a, there is a problem in that the size of the conventional non-reciprocal circuit element is large in the horizontal direction.

In addition, since the first to third central conductors 56, 57, and 58 are bent to cover the ferrite member 55, the manufacturing work is troublesome. In addition, when the first to third central conductors 56, 57, and 58 are bent, the positional difference may occur among the first to third central conductors 56, 57, and 58. As a result, there is a problem in that the performance deteriorates.

In addition, since the ferrite member 55 on which the first to third central conductors 56, 57, and 58 are mounted and the first to third capacitors C1, C2, and C3 are accommodated in the resin case 54, the assembling work is troublesome. As a result, there is a problem in that the conventional non-reciprocal circuit element has poor productivity and requires high cost.

In addition, after the first to third capacitors C1, C2, and C3 are accommodated in the resin case 54, the port portions 56b, 57b, and 58b of the first to third central conductors 56, 57, and 58 should be soldered to the capacitors C1, C2, and C3 in the small space, and thus the manufacturing work is troublesome. As a result, there is a problem in that the conventional non-reciprocal circuit element has poor productivity and requires high cost.

### SUMMARY OF THE INVENTION

Accordingly, it is an object of the present invention to provide a non-reciprocal circuit element which is small in size in a horizontal direction, is expensive, and has superior assembling characteristic, productivity, and performance.

In order to solve the above-mentioned problems, according to a first aspect of the present invention, there is provided a non-reciprocal circuit element comprising a first yoke having an upper plate, a magnet disposed on a lower surface of the upper plate, a second yoke which has a flat plate-shaped lower plate and which forms a magnetic closed circuit together with the first yoke, a flat plate-shaped ferrite member disposed on the lower plate, a bendable dielectric which is disposed between the magnet and the ferrite member and which is made of a laminated plate in which a plurality of insulating thin plates are laminated, first to third central conductors which are formed at different laminated locations of the dielectric to be integrated with the dielectric and which are disposed such that parts the first to third central conductors cross each other in a vertical direction, and a plurality of capacitors disposed between the dielectric and one of the first and second yokes. At least one of the first and second yokes has side plates bent from the upper plate or the lower plate. The dielectric has a base portion disposed on the ferrite member and bent portions bent from the base portion so as to face the side plates. One electrode of each of the capacitors is connected to the corresponding central conductor and the other electrode of each of the capacitors is connected to the corresponding side plate in a state in which the capacitors are disposed between the side plates and the bent portions.

According to a second aspect of the present invention, the dielectric has a pair of the bent portions bent from opposite sides of the base portion, and the capacitors are disposed between the bent portions and the side plates.

According to a third aspect of the present invention, the bent portions are bent toward side surfaces of the ferrite member.

According to a fourth aspect of the present invention, each of the central conductors has a ground portion connected to the corresponding yoke and a port portion connected to the one electrode of each of the capacitors. Conductive patterns are provided on surfaces of the dielectric facing the side plates, each of conductive patterns being connected to the port portion of the corresponding central conductor. The one electrode of each of the capacitors is connected to the corresponding conductive pattern.

According to a fifth aspect of the present invention, each of the bent portion is formed by bending the dielectric in a state in which each of the capacitor is soldered on the corresponding conductive pattern. Further, the dielectric is accommodated in the yokes in a state in which each of the capacitor is provided on the corresponding bent portion.

According to a sixth aspect of the present invention, the dielectric is provided with terminal portions which are connected to the conductive patterns, and the terminal portions protrude outside the yokes.

According to a seventh aspect of the present invention, the dielectric has tongue pieces extended upright from the base portions when the bent portions are formed, and the capacitors are supported by the tongue pieces.

According to an eighth aspect of the present invention, each of the central conductors has a ground portion connected to the lower plate of the second yoke, and the ground portion is connected to the lower plate through a connecting conductor which is formed in a through hole provided in the dielectric and a concave portion provided in the ferrite member.

A non-reciprocal circuit element according to the present invention comprises a first yoke having an upper plate, a magnet disposed on a lower surface of the upper plate, a second yoke which has a flat plate-shaped lower plate and which forms a magnetic closed circuit together with the first yoke, a flat plate-shaped ferrite member disposed on the lower plate, a bendable dielectric which is disposed between the magnet and the ferrite member and which is made of a laminated plate in which a plurality of insulating thin plates are laminated, first to third central conductors which are formed at different laminated locations of the dielectric to be integrated with the dielectric and which are disposed such that parts the first to third central conductors cross each other in a vertical direction, and a plurality of capacitors disposed between the dielectric and one of the first and second yokes. At least one of the first and second yokes has side plates bent from the upper plate or the lower plate. The dielectric has a base portion located on the ferrite member and bent portions bent from the base portion so as to face the side plates. One electrode of each of the capacitors is connected to the corresponding central conductor and the other electrode of each of the capacitors is connected to the corresponding side plate in a state in which the capacitors are disposed between the side plates and the bent portions.

As such, when the capacitors are disposed between the side plates and the bent portions, the flat portions (thickness direction) of the capacitors are in an upright state with respect to the lower plate. As a result, as compared to the conventional non-reciprocal circuit element, the non-reciprocal circuit element which is small in size in a horizontal direction can be obtained.

In addition, the central conductors are laminated in the dielectric to be integrated with the dielectric. Thus, the positional difference among the central conductors is small as compared to the conventional non-reciprocal circuit element in which the central conductors are bent. As a result, the non-reciprocal circuit element having a superior performance can be obtained.

Further, the dielectric has a pair of the bent portions bent from opposite sides of the base portion, and the capacitors are disposed between the bent portions and the side plates. Thus, the capacitors can be decentralized. As a result, the non-reciprocal circuit element which is small and has a superior assembling characteristic can be obtained.

Further, the bent portions are bent toward side surfaces of the ferrite member. Thus, the capacitors can be arranged on the upper surface of the dielectric. As a result, the mounting work of the capacitors can be favorably performed.

Further, each of the central conductors has a ground portion connected to the yokes and a port portion connected to the one electrode of each of the capacitors. Conductive patterns are provided on surfaces of the dielectric facing the side plates, each of the conductive patterns being connected to the port portion of the corresponding central conductor. The one electrode of each of the capacitors is connected to the corresponding conductive pattern. Thus, the capacitors can be easily connected to the central conductors. As a result, the non-reciprocal circuit element which has a superior productivity can be obtained.

Further, the bent portions are formed by bending the dielectric in a state in which the capacitors are soldered to the conductive patterns. The dielectric is accommodated in the yokes in a state in which the capacitors are provided on the bent portions. Thus, the assembling work can be easily performed as compared to the conventional non-reciprocal circuit element. As a result, the non-reciprocal circuit element which has a superior productivity and is expensive can be obtained.

Further, the dielectric is provided with terminal portions connected to the conductive patterns, and the terminal portions protrude outside the yokes. As a result, the non-reciprocal circuit element which can be easily connected to an external circuit can be obtained.

Further, the dielectric has tongue pieces extended upright from the base portion when the bent portions are formed, and the capacitors are supported by the tongue pieces. As a result, the tongue pieces can be easily formed and the capacitors can be surely supported.

Further, each of the central conductors has a ground portion connected to the lower plate of the second yoke, and the ground portion is connected to the lower plate through a connecting conductor which is formed in a through hole provided in the dielectric and a concave portion provided in the ferrite member. Thus, a structure for connecting the ground portion to the lower plate is simple. As a result, the non-reciprocal circuit element which has a superior assembling characteristic can be obtained.

### BRIEF DESCRIPTION OF THE DRAWINGS

FIG. 1 is a schematic cross-sectional view of a non-reciprocal circuit element according to the present invention;

FIG. 2 is a plan view of the non-reciprocal circuit element according to the present invention in a state in which a first yoke and a magnet are removed therefrom;

FIG. 3 is an extended elevational view of a dielectric in the non-reciprocal circuit element according to the present invention;

FIG. 4 is an extended elevational view of the non-reciprocal circuit element according to the present invention in a state which a capacitor is attached to the dielectric;

FIG. 5 is a perspective view of the dielectric in the non-reciprocal circuit element according to the present invention; and

FIG. 6 is an exploded perspective view of a conventional non-reciprocal circuit element.

### DESCRIPTION OF THE PREFERRED EMBODIMENTS

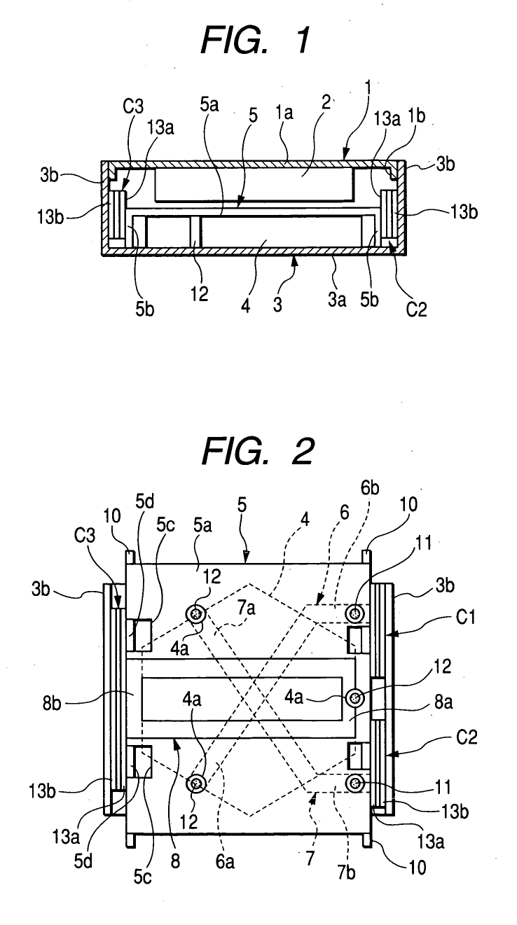

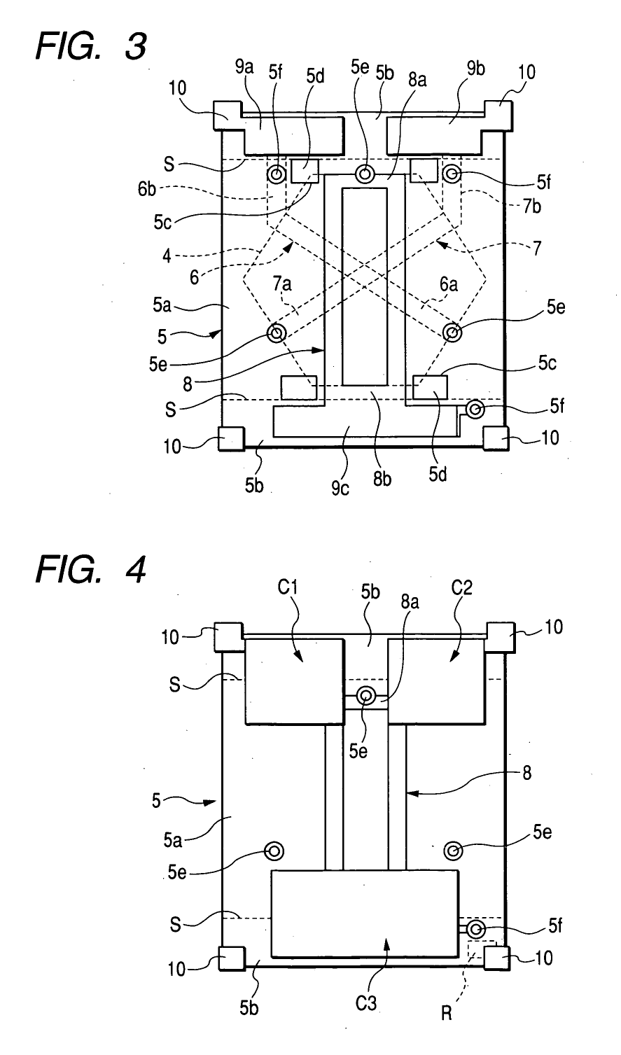

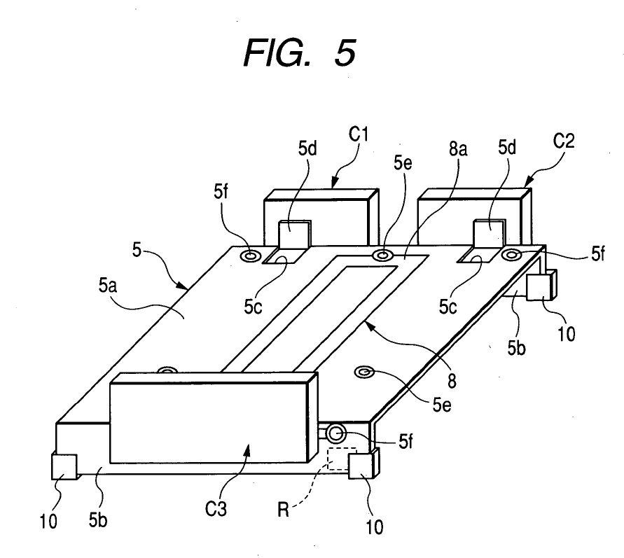

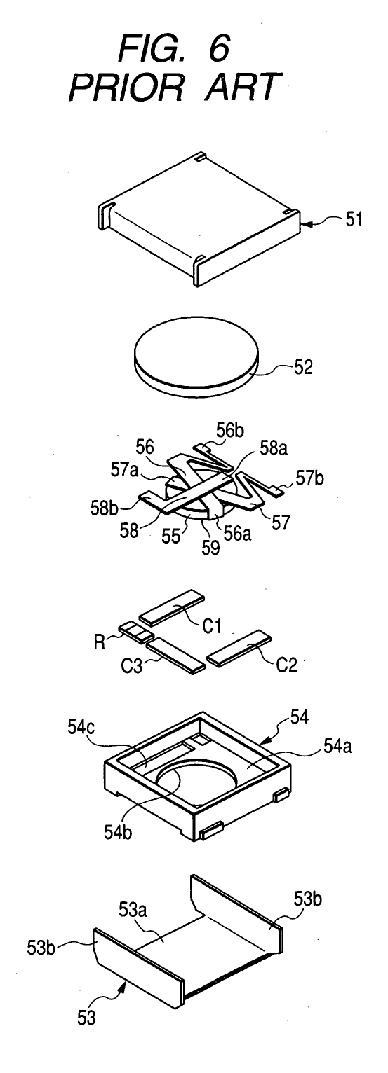

A non-reciprocal circuit element of the present invention will be described with reference to the drawings. FIG. 1 is a schematic cross-sectional view of a non-reciprocal circuit element according to the present invention. FIG. 2 is a plan view of the non-reciprocal circuit element according to the present invention in a state in which a first yoke and a magnet are removed therefrom. FIG. 3 is an extended elevational view of a dielectric in the non-reciprocal circuit element of the present invention. FIG. 4 is an extended elevational view of the non-reciprocal circuit element according to the present invention in a state in which a capacitor is attached to the dielectric. FIG. 5 is a perspective view of the dielectric in the non-reciprocal circuit element according to the present invention.

Next, a configuration in a case where the non-reciprocal circuit element of the present invention is applied to an isolator will be described with reference to FIGS. 1 to 5. A U-shaped first yoke 1 made of a boxlike magnetic plate (iron plate or the like) has an upper plate 1a having a rectangular shape and two side plates 1b bent downward from two opposite sides of the upper plate 1a.

A magnet 2 having a rectangular shape is attached to the first yoke 1 by means of a suitable means such as adhesive or the like in a state in which the magnet 2 is located within the boxlike first yoke 1 and in which a upper surface of the magnet 2 comes into contact with an inner surface of the upper plate 1a.

A U-shaped second yoke 3 made of a magnetic plate (iron plate or the like) has a lower plate 3a having a rectangular shape and two side plates 3b bent upward from two opposite sides of the lower plate 3a. The side plates 1b and 3b of the first and second yokes 1 and 3 are coupled with each other, so that the first and second yokes 1 and 3 form a magnetic closed circuit.

A ferrite member 4 which is made of YIG (Yttrium iron garnet) or the like and which has a flat plate shape such as a polygonal shape (a hexagonal shape) or the like has three concave portions 4a formed on sides in every other one. A lower surface of the ferrite member 4 comes in contact with the lower plate 3a and then it is fixed on the lower plate 3a by a suitable means.

A bendable dielectric 5 is made of a laminated plate in which a plurality of insulating thin plates such as insulating films are laminated. At different laminated locations of the dielectric 5 that has a rectangular shape, first to third central conductors 6, 7, and 8 that are made of a metal thin plate such as copper or a conductive film are formed. The first to third central conductors 6, 7, and 8 are disposed in a manner that parts the first to third central conductors cross each other in a vertical direction via the dielectric 5.

In addition, as shown in FIGS. 3 to 5, in particular, the dielectric 5 includes a base portion 5a having a flat plate shape, a pair of bent portions 5b bent downward from two opposite sides of the base portion 5a, a plurality of clamp-shaped notch portions 5c provided in the base portion 5a near the bent portions 5b, a plurality of tongue pieces 5d extended upright from the base portion 5a at locations of the bent portions 5b, and a plurality of first and second through holes 5e and 5f.

In addition, on an upper surface of the dielectric 5, first to third conductive patterns 9a, 9b, and 9c and a plurality of terminal portions 10 connected to at least the first and second conductive patterns 9a and 9b are provided.

In addition, the first to third central conductors 6, 7, and 8 have ground portions 6a, 7a, and 8a at one end respectively, and the ground portions 6a, 7a, and 8a are provided to be exposed through the first through holes 5e.

In addition, the first to third central conductors 6, 7, and 8 have port portions 6b, 7b, and 8b at the other end respectively, and the port portions 6b, 7b, and 8b are provided to be exposed through the second through holes 5f.

In addition, connectors (through holes) 11 are provided in the second through holes 5f. The port portion 6b is connected to the first conductive pattern 9a, the port portion 7b is connected to the second conductive pattern 9b, and the port portion 8b is connected to the third conductive pattern 9c.

First to third capacitors C1, C2, and C3 are made of chip type capacitors. Electrodes 13a located on the upper surfaces of the first to third capacitors C1, C2, and C3 are respectively soldered, connected and fixed to the first to third conductive patterns 9a, 9b, and 9c. Further, a chip type resistor R is fixed to the dielectric 5 at a side opposite to the side where the first to third capacitors C1, C2 and C3 are mounted on the dielectric 5.

In addition, one electrode portion of the resistor R is connected to one electrode 13a of the third capacitor C3 and the other electrode portion thereof is grounded.

Next, a manufacturing method of the dielectric 5 having the above-mentioned configuration will be described with reference to FIGS. 3 to 5. As shown in FIG. 3, the dielectric 5 having the flat plate shape is prepared. And then, as shown in FIG. 4, the first to third capacitors C1, C2, and C3 are soldered to the first to third conductive patterns 9a, 9b, and 9c, and simultaneously the resistor R is mounted.

Next, when the dielectric 5 is bent along a bending line S, the base portion 5a, the bent portions 5b, the first to third capacitors C1, C2, and C3 and the resistor R which are provided upright along the bent portions 5b, and the tongue pieces 5d which extend upright from the base portion 5a and which support the first to third capacitors C1, C2, and C3 respectively are formed.

Therefore, in the dielectric 5, the first to third central conductors 6, 7, and 8, the first to third capacitors C1, C2, and C3, and the resistor R are integrally formed. In this state, the dielectric 5 is accommodated in the first and second yokes 1 and 3.

At this time, the bent portions 5b of the dielectric 5 face the side plates 3b and the side surfaces of the ferrite member 4, and the other electrodes 13b of the first to third capacitors C1, C2, and C3 come into contacts with the side plates 3b and are soldered thereto. As a result, the flat portions (thickness direction) of the first to third capacitors C1, C2 and C3 are provided upright with respect to the lower plate 3a.

In addition, the base portion 5a of the dielectric 5 is arranged on the upper surface of the ferrite member 4. The connecting conductors (through holes) 12 are provided in the second through holes 5f of the dielectric 5 and the concave portions 4a of the ferrite member 4. By using the connecting conductors 12, the ground portions 6a, 7a, and 8a of the first to third central conductors 6, 7, and 8 are grounded through the lower plate 3a of the second yoke 3.

In addition, when the dielectric 5 is accommodated in the first and second yokes 1 and 3, the first and second yokes 1 and 3 are coupled with each other in a state in which the terminal portions 10 protrude outside the first and second yokes 1 and 3 and in which the magnet 2, the dielectric 5, and the ferrite member 4 are interposed between the first and second yokes 1 and 3. As a result, the first and second yokes 1 and 3 form the magnetic closed circuit, so that the non-reciprocal circuit element of the present invention is constructed.

In addition, in the above-mentioned embodiment, the present invention is applied to the isolator. However, the present invention can be applied to the circulator in which the resistor R is removed.

1. A non-reciprocal circuit element comprising:
a first yoke having an upper plate;
a magnet disposed on a lower surface of the upper plate;
a second yoke which has a flat plate-shaped lower plate and which forms a magnetic closed circuit together with the first yoke;
a flat plate-shaped ferrite member disposed on the lower plate;
a bendable dielectric disposed between the magnet and the ferrite member and which is made of a laminated plate having a plurality of laminated insulating thin plates;
first to third central conductors which are formed at different laminated locations of the dielectric to be integrated with the dielectric and which are disposed in a manner that parts of the first to third central conductors cross each other in a vertical direction; and
a plurality of capacitors disposed between the dielectric and one of the first and second yokes,
wherein at least one of the first and second yokes has side plates bent from the upper plate or the lower plate,
the dielectric has a base portion disposed on the ferrite member and bent portions bent from the base portion so as to face the side plates, and
one electrode of each of the capacitors is connected to the corresponding central conductor and another electrode is connected to the corresponding side plate in a state in which the capacitors are disposed between the side plates and the bent portions.

2. The non-reciprocal circuit element according to claim 1,
wherein the dielectric has a pair of the bent portions bent from opposite sides of the base portion, and
the capacitors are disposed between the bent portions and the side plates.

3. The non-reciprocal circuit element according to claim 1,
wherein the bent portions are bent toward side surfaces of the ferrite member.

4. The non-reciprocal circuit element according to claim 1,
wherein each of the central conductors has a ground portion connected to the corresponding yoke and a port portion connected to the one electrode of each of the capacitors,
conductive patterns are provided on surfaces of the dielectric facing the side plate, each of the conductive patterns being connected to the port portion of the corresponding central conductor, and
the one electrode of each of the capacitors is connected to the corresponding conductive pattern.

5. The non-reciprocal circuit element according to claim 4,
wherein the bent portions are formed by bending the dielectric in a state in which the capacitors are soldered to the conductive patterns, and
the dielectric is accommodated in the yokes in a state in which the capacitors are provided on the bent portions.

6. The non-reciprocal circuit element according to claim 4,
wherein the dielectric is provided with terminal portions connected to the conductive patterns, and the terminal portions protrude outside the yokes.

7. The non-reciprocal circuit element according to claim 1,
wherein the dielectric has tongue pieces extended upright from the base portion when the bent portions are formed, and the capacitors are supported by the tongue pieces.

8. The non-reciprocal circuit element according to claim 1,
wherein each central conductor has a ground portion connected to the lower plate of the second yoke, and
the ground portion is connected to the lower plate through a connecting conductor which is formed in a through hole provided in the dielectric and a concave portion provided in the ferrite member.
